(19) United States
(12) Patent Application Publication
(10) Pub. No.: US 2011/0035684 A1
(43) Pub. Date: Feb. 10, 2011

(54) Collaborative Virtual Reality System Using Multiple Motion Capture Systems and Multiple Interactive Clients

(75) Inventors: George Steven Lewis, Alvarado, TX (US); John Valentino, II, Hurst, TX (US)

Correspondence Address: LAW OFFICES OF JAMES E. WALTON, PLLC, 1169 N. BURLESON BLVD., SUITE 107-328, BURLESON, TX, 76028, US

(73) Assignee: BELL HELICOPER TEXTRON INC., FORT WORTH, TX (US)

(21) Appl. No.: 12/595,373

(22) PCT Filed: Apr. 17, 2008
(86) PCT No.: PCT/US08/60562

§ 371 Date: Oct. 9, 2009

Related U.S. Application Data
(60) Provisional application No. 60/912,280, filed on Apr. 17, 2007.

(51) Int. Cl. G06F 3/00

(52) U.S. Cl. 715/753

(57) ABSTRACT

A collaborative virtual reality system includes a first motion capture system and a second motion capture system. The first motion capture system and the second motion capture system configured to interact over a network to produce a single virtual reality environment.

### TECHNICAL FIELD

The present invention relates in general to the field of virtual environments.

### DESCRIPTION OF THE PRIOR ART

Virtual reality is a technology which allows a user or “actor” to interact with a computer-simulated environment, be it a real or imagined one. Most current virtual reality environments are primarily visual experiences, displayed either on a computer screen or through special stereoscopic displays. An actor can interact with a virtual reality environment or a virtual artifact within the virtual reality environment either through the use of standard input devices, such as a keyboard and mouse, or through multimodal devices, such as a wired glove.

FIG. 1 depicts a plurality of conventional motion capture systems 101a-101c. Each of motion capture systems 101a-101c includes a motion capture environment 103a-103c, respectively, and tracking technologies 105a-105c, respectively. Tracking technologies 105a-105c are, for example, sensors and reflectors that sense movement of an actor. Motion capture environments 103a-103c are softwares that interpret information from tracking technologies 105a-105c to produce their corresponding virtual reality scenes. Motion capture systems 101a-101c exist at different geographical locations and may use different types of technologies to track the movements of actors using motion capture systems 101a-101c. Each of motion capture systems 101a-101c are independent and unaware of each other.

Conventionally, actors participating in a particular virtual reality environment must use the same motion capture system, e.g., motion capture system 101a-101c, and be in the same physical location, i.e., in the same “studio.” Accordingly, actors that are principally located in different geographical locations, such as in different locations around the world, must co-locate in order to participate in the same virtual reality environment.

There are ways of participating in virtual reality environments well known in the art; however, considerable shortcomings remain.

### BRIEF DESCRIPTION OF THE DRAWINGS

The novel features believed characteristic of the invention are set forth in the appended claims. However, the invention itself, as well as a preferred mode of use, and further objectives and advantages thereof, will best be understood by reference to the following detailed description when read in conjunction with the accompanying drawings, in which the leftmost significant digit(s) in the reference numerals denote(s) the first figure in which the respective reference numerals appear, wherein:

FIG. 1 is FIG. 1 is a block diagram depicting a conventional configuration of motion capture systems;

FIG. 2 is block diagram depicting a first illustrative embodiment of a collaborative virtual reality system;

FIG. 3 is a block diagram depicting a second illustrative embodiment of a collaborative virtual reality system;

FIG. 4 is a block diagram depicting an interaction between certain components of a collaborative virtual reality system; and

FIG. 5 is a stylized, graphical representation of a particular implementation of the collaborative virtual reality system of FIG. 3.

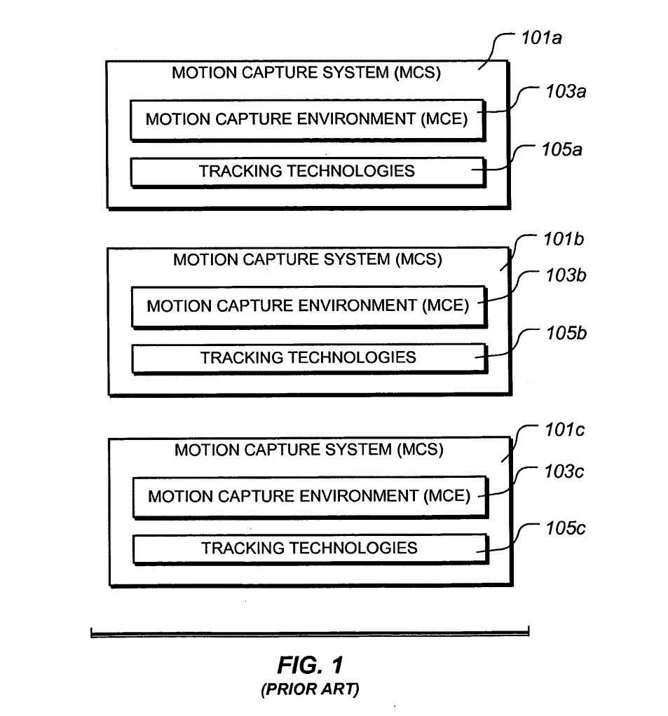

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DESCRIPTION OF THE PREFERRED EMBODIMENT

Illustrative embodiments of the invention are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

For the purposes of this disclosure, the term “studio” means a three-dimensional, physical space in which one or more actors can move objects that are tracked using sensors, i.e., “tracker-sensors.” A “motion capture environment” or “MCE” is contained by the studio and includes computer hardware and software used to interpret information from the tracker sensors and generate virtual reality scenes. A “motion capture system” or “MCS” includes the motion capture environment and the associated tracking technology and hardware, such as tracker gloves, cameras, computers, and the like, as well as a framework upon which to mount tracker-sensors and/or tracker-sensor combinations. The terms “motion capture” and “motion tracking” are used interchangeably herein.

A “virtual reality scene” or “VRS” is a virtual scene that an actor or an observer sees in a headset/viewer, computer monitor, or other such electronic display device. The virtual reality scene may be a virtual representation of the studio or a virtual world, such as a representation of a ship deck or any other real or imagined three-dimensional space. An “actor” is a person using the studio and the motion capture environment. A “sensor glove” is a real-world glove worn by an actor that is used to relay the movements of the actor's hand and fingers to the motion capture system. A “multi-modal device” is any real-world device, such as a sensor glove, that is used to transmit particular data to the motion capture system.

A “traditional tracked object” is an object having a position and/or orientation that is of interest A traditional tracked object has a group of reflectors or other such trackable media attached thereto that are sensed by the tracker sensors. Examples of a tracked object include, but are not limited to, a wand, a glove, and a headset worn by an actor in the studio. Preferably, tracked objects include a glove having reflectors that can be tracked and a headset with reflectors that can be tracked and a viewer. A “tracking costume” means a set of tracked objects, such as a glove and a headset. A “tracker-sensor” is a device that determines where a tracked object has moved within a physical space. A tracker-sensor may include one unit or more than one unit. A tracker-sensor may be attached to a framework that defines the physical limits of the studio or may be attached to a tracked object. Technologies used to track tracked objects include, but are not limited to, inertial acceleration with subsequent integration to rate and displacement information, ultrasonic measurement, optical measurement, near infrared (NIR) measurement, optical measurement within bands of the electromagnetic spectrum other than the near infrared band, or the like.

A “non-traditional tracked object” is any object, real or simulated, whose position and/or orientation is of some interest. A non-traditional tracked object can be real or simulated. Non-traditional tracked objects are objects not necessarily bound to a virtual reality motion capture studio whose motions can be tracked using widely varied technologies such as global positioning satellite (GPS) systems, radar, image interpretation/pattern recognition, or other such objects having motion that can be synthesized by means of a computer simulation.

The term “tracking technologies” means devices and/or systems used to track the motion of one or more traditional tracked objects and/or non-traditional tracked objects.

The term “data service” means a service provided by a computer program or group of programs that transmit particular data to any number of other computer programs requesting the information. For example, a data service will communicate tracking data to a visual client. Data Services are used to “wrap” existing data technologies of interest in order to convert the existing data into formats that are understandable and usable to the overall virtual reality system. For example, motion data generated from a reflector technology motion capture system would be converted from its native format in to a common format recognizable to each visual client and the host. Similarly, motion data derived from a GPS system, radar simulation, etc., would be converted into the same common format. Common formats are also created and employed for motion capture systems of any technology and all multi-modal effectors of different technologies operating in the collaborative virtual reality environment. Use of data service wrappers enables wide varieties of systems and technologies to participate together in one virtual reality environment.

The term “visual client” means software used to visualize and interact with one or more motion capture environments. Visual clients, as described herein, are “fat clients,” meaning that most of the processing is done on the client computer as opposed to the host. Each visual client controls its own views of the virtual reality scene including such things as viewing position, e.g., eyepoint, and rendering modes, e.g., transparent, solid, line art, or the like. The viewing options of each individual client are independent and have no effect on the viewing options of any other visual client. However, each visual client also possesses the ability to add, delete, and manipulate objects in the shared virtual reality scene. For example, a user from one visual client may simulate a “grabbed” state for a virtual object by selecting it with a mouse click or similar operation. The user may then move the virtual object with a mouse drag event or other similar operation indicating the effect of a state of motion. The grabbed and motion states of the object will be communicated to the host which will redistribute distribute those states to every other visual client. This example demonstrates one way in which different motion tracking technologies may be integrated. In this example, the mouse click from a typical desktop computer has the same effect as an actor inside a physical motion capture studio making a grab gesture on a virtual object using a sensor glove, while the mouse drag event has the same effect as an actor moving within the physical motion capture studio while maintaining a grabbed state for that virtual object. All actions and object states processed by a visual client are forwarded to the host for redistribution.

The “host” computer system acts as a supervisor to ensure that the virtual object states e.g., position, selected, added, deleted, grabbed, dropped, hidden, visible, in motion, etc., are synchronized between all participating visual clients but does not actually process the virtual reality scene itself. A typical scenario for host functions will be to first deliver a simulation and its configuration to one or more visual clients upon startup. The startup may either be requested by a client, or may be “pushed” to a client or clients per a host command. The host will also keep track of all participating visual clients and data servers. If, during the course of the simulation an additional visual client or data server joins, the host will publish the address of the new data server to all participating visual clients. The visual clients need not be aware of other visual clients. The host will accumulate a queue of all actions occurring in the virtual reality scene over the course of the simulation as they are processed by the visual clients. If a new visual client joins after simulation startup the host will send all actions in the queue to the new visual client such that the newcomer will initialize to the current state of the collaborative simulation. If a visual client receives an action or object state from the host that the visual client has already processed via direct communication with a data server, the visual client will ignore the duplicate instruction from the host.

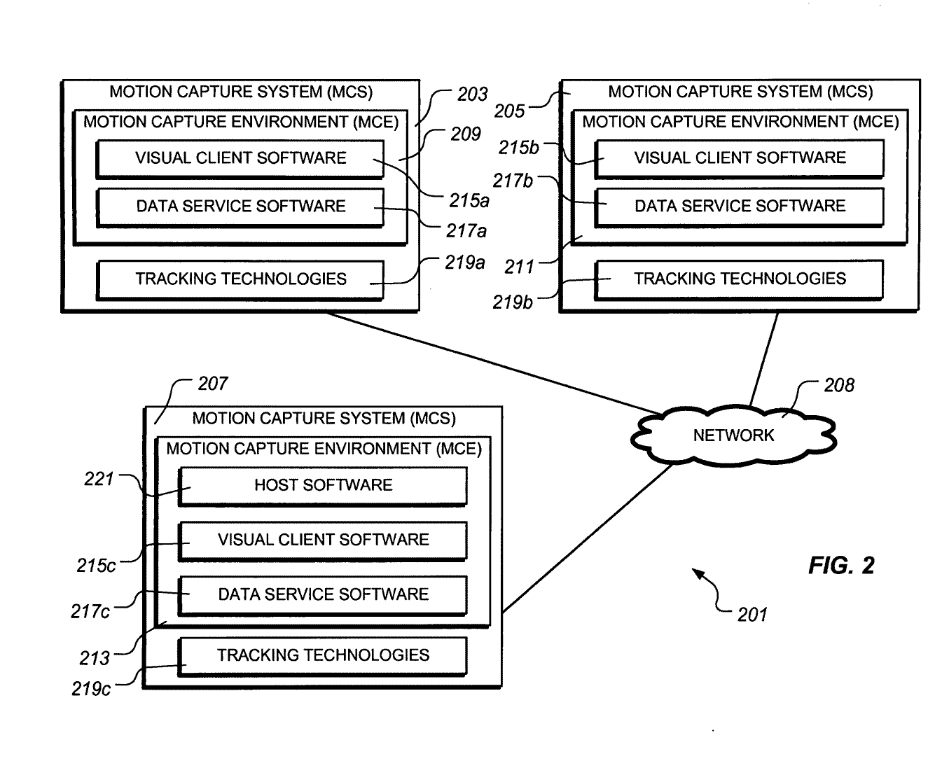

FIG. 2 depicts a first illustrative embodiment of a collaborative virtual reality system 201 comprising a plurality of motion capture systems 203, 205, and 207 that interact over a network 208, which may include the World Wide Web. It should be noted that collaborative virtual reality system 201 may comprise two or more motion capture systems, e.g., motion capture systems 203, 205, and 207. Each of the plurality of motion capture systems 203, 205, and 207 comprises a motion capture environment 209, 211, and 213, respectively. Each motion capture environment 209, 211, and 213 comprises a visual client 215a-c, respectively; a data service 217a-c, respectively; and tracking technologies 219a-c, respectively. It should be noted that motion capture systems 203, 205 and 207 may comprise different hardware and software components. Thus, motion capture environments 209, 211, and 213 may operate differently and may construct data in different formats.

One motion capture environment, i.e., motion capture environment 213 of motion capture system 207 in the illustrated embodiment, further comprises a host 221. Host 221 has primary control over the virtual reality environment and, thus, motion capture system 207 is the location to which motion capture systems 203 and 205, as well as any other motion capture systems, initially connect so that host 221 can obtain the locations of the participating motion capture systems. Host 221 maintains an awareness of the locations of all data services, e.g., data services 217a-217c, with the various motion capture systems, e.g., motion capture systems 203, 205, and 207, of collaborative virtual reality system 201. Host 221 comprises computer hardware and software to accomplish the activities disclosed herein.

A data service 217a, 217b, or 217c of a particular motion capture system, e.g., motion capture systems 203, 205, and 207, places data from tracking technologies 219a, 219b, or 219c, respectively, into one or more data formats understood by and available to software and hardware of the other motion capture systems 203, 205 and 207. Visual clients 215a-c are used to visualize and interact with shared motion capture systems 203, 205, and 207.

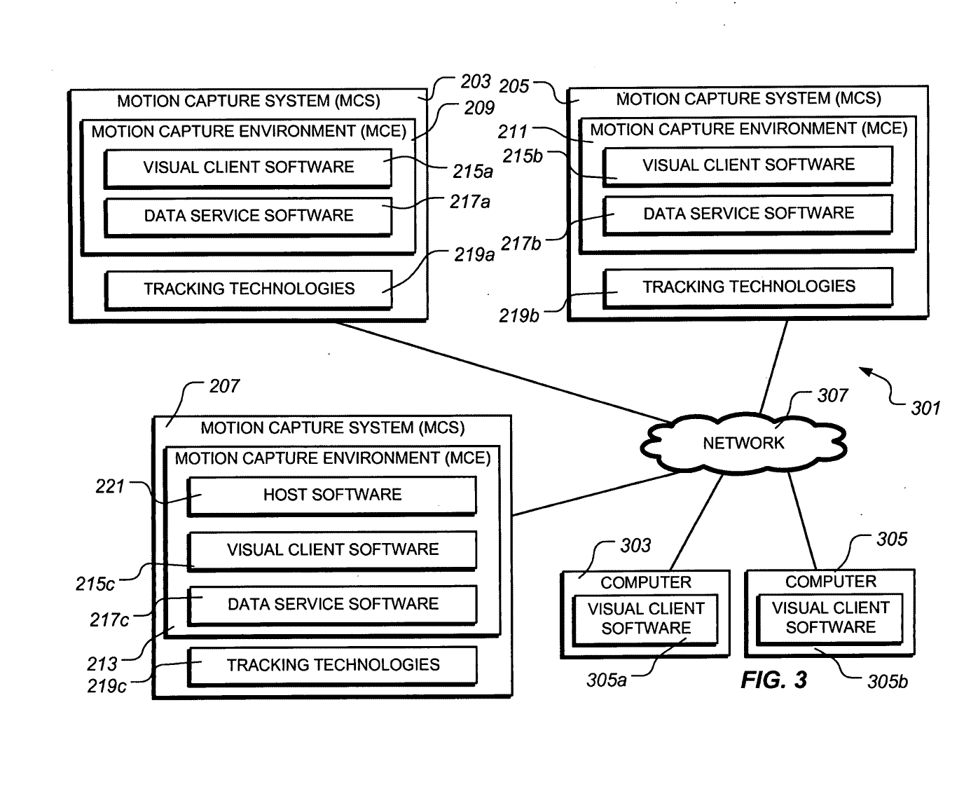

Visual clients, however, are not limited to operation within motion capture systems. Rather, visual clients may be run on any computer from any location worldwide. Referring to FIG. 3, a second embodiment of a collaborative virtual reality system 301 comprises motion capture systems 203, 205, and 207 as well as computers 303 and 305, interconnected over a network 307, which may include the World Wide Web. It should be noted that, while motion capture systems 203, 205, and 207 are motion capture systems of the collaborative virtual reality system 301, this configuration is merely exemplary and, accordingly, the scope of the present invention is not so limited. Collaborative virtual reality system 301 may comprise motion capture systems other than or in addition to motion capture systems 203, 205, and/or 207, as well as computers other than or in addition to computers 303 and 305.

Still referring to FIG. 3, computers 303 and 305 comprise visual clients 305a and 305b, respectively. Host 221 maintains an awareness of the locations of all data services, e.g., data services 217a-217c, with the various motion capture systems, e.g., motion capture systems 203, 205, and 207, of collaborative virtual reality system 301. Visual clients 305a and 305b connect to host 221 to download the shared virtual reality scene and to obtain the locations of the various data services to use for that scene.

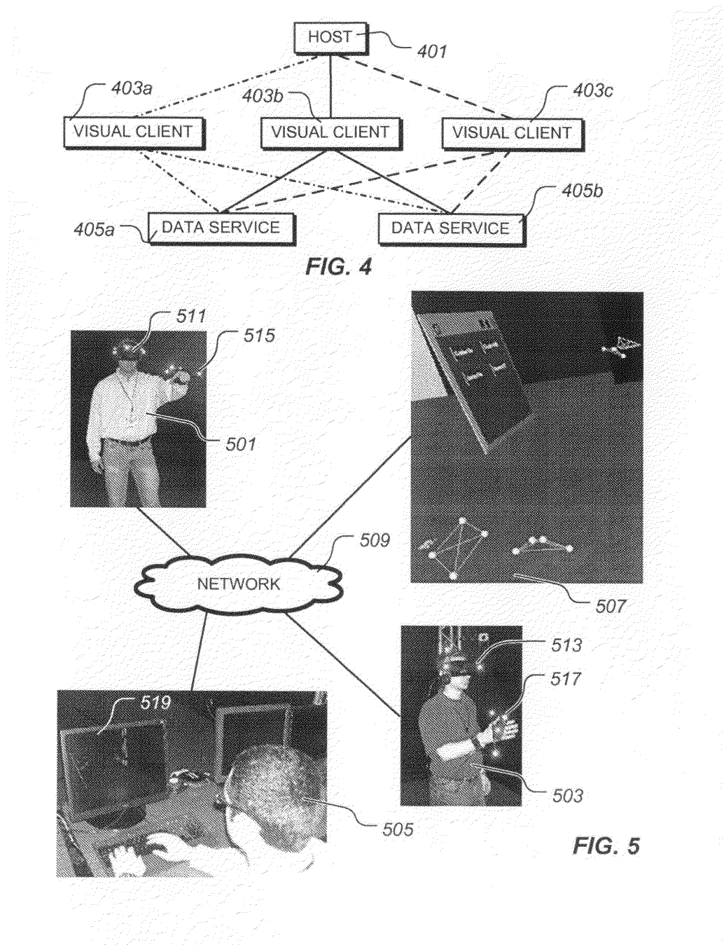

FIG. 4 depicts one particular interaction scheme between a host 401, e.g., host 221; visual clients 403a-403c, e.g., visual clients 215a-c; and data services 405a-405b, e.g., data services 217a-217c. Note that host 221, visual clients 215a-c, and data services 217a-217c are shown in FIGS. 2 and 3. In the illustrated embodiment, host 401 communicates with visual clients 403a-403c. Visual clients 403a-403c communicate with data services 405a-405b. Visual clients 403a-403c are not dependent upon a motion capture system. Visual clients 403a-403c can be operated at any location and on any computer capable of supporting such a visual client.

FIG. 5 depicts an illustrative implementation of collaborative virtual reality system 301 of FIG. 3. In the illustrated implementation, three actors 501, 503, and 505 are interacting in a shared motion capture environment 507, even though actors 501, 503, and 505 are in three different geographic locations. Actors 501, 503, and 505 are interacting with shared motion capture environment 507 via network 509. Actors 501 and 503 are interacting with shared motion capture environment 507 via head mounted displays 511 and 513 and via sensor gloves 515 and 517. Actor 505 is interacting with shared motion capture environment 507 via a desktop computer 519.

It should be noted that motion capture systems 203, 205, and 207, shown in FIGS. 2 and 3, each comprise one or more computers executing software embodied in a computer-readable medium that is operable to produce and control the virtual reality environment. Computers 303 and 305, shown in FIG. 3, each comprise one or more computers executing software embodied in a computer-readable medium that is operable to interact with the virtual reality environment.

The present invention provides significant advantages, including: (1) allowing actors located remotely from one another to interact with a single virtual reality environment; (2) allowing a single motion capture system to contain simultaneously running motion capture environments; and (3) readily integrating various motion capture sensors such as infra-red cameras and inertial sensors and motion capture emulators such as recorded data streams, computer mouse controllers, keypads, and sensor gloves into a single virtual reality environment.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below. It is apparent that an invention with significant advantages has been described and illustrated. Although the present invention is shown in a limited number of forms, it is not limited to just these forms, but is amenable to various changes and modifications without departing from the spirit thereof.

1. A collaborative virtual reality system, comprising:
a first motion capture system; and
a second motion capture system, the first motion capture system and the second motion capture system configured to interact over a network to produce a single virtual reality environment.

2. The collaborative virtual reality system of claim 1, wherein the network includes the World Wide Web.

3. The collaborative virtual reality system of claim 1, wherein the first motion capture system includes a host for controlling the single virtual reality environment.

4. The collaborative virtual reality system of claim 1, wherein:
the first motion capture system comprises:
a motion capture environment including a visual client, a data service, and a host; and
the second motion capture system comprises:
a motion capture environment including a visual client and a data service;
wherein the host controls the single virtual reality environment.

5. The collaborative virtual reality system of claim 4, wherein each of the first motion capture system and the second motion capture system include one or more tracking technologies.

6. The collaborative virtual reality system of claim 1, further comprising:
a computer operating a virtual client, the computer configured to interact in the single virtual reality environment over the network.

7. The collaborative virtual reality system of claim 6, wherein the network includes the World Wide Web.

8. The collaborative virtual reality system of claim 1, wherein the first motion capture system is configured to provide a virtual reality scene from the single virtual reality environment to a first actor and the second motion capture system is configured to provide a virtual reality scene from the single virtual reality environment to a second actor.

9. The collaborative virtual reality system of claim 8, wherein the first motion capture system and the second motion capture system are configured to provide the same virtual reality scene to each of the first actor and the second actor.

10. The collaborative virtual reality system of claim 8, wherein the first actor is located at a first geographical location and the second actor is located at a second geographical location remote from the first geographical location.

11. The collaborative virtual reality system of claim 8, wherein the first motion capture system and the second motion capture system are configured to provide different virtual reality scenes of the virtual reality environment to each of the first actor and the second actor.

12. The collaborative virtual reality system of claim 1, wherein the first motion capture environment is operably associated with a studio located at a first geographical location and the second motion capture environment is operably associated with a studio located at a second geographical location remote from the first geographical location.

13. A method, comprising:
providing a first motion capture system and a second motion capture system configured to interact over a network;
establishing a single virtual reality environment using the first motion capture system and the second motion capture system; and
interacting with the single virtual reality environment;

14. The method, according to claim 13, wherein providing the first motion capture system and the second motion capture system is accomplished by locating the first motion capture system at a first geographical location and locating the second motion capture system at a second geographical location remote from the first geographical location.
